(19) United States
(12) Patent Application Publication
(10) Pub. No.: US 2018/0253538 A1
(43) Pub. Date: Sep. 6, 2018

(54) METHOD AND DEVICE FOR CONTROLLING TOP FLOATING WINDOW AND MOBILE TERMINAL

(71) Applicant: BEIJING KINGSOFT INTERNET SECURITY SOFTWARE CO., LTD., BEIJING (CN)

(72) Inventors: Yian LIN, BEIJING (CN); Xiaojie CAI, BEIJING (CN); Zhenyu YANG, BEIJING (CN)

(73) Assignee: BEIJING KINGSOFT INTERNET SECURITY SOFTWARE CO., LTD., BEIJING (CN)

(21) Appl. No.: 15/756,930

(22) PCT Filed: Aug. 18, 2016
(86) PCT No.: PCT/CN2016/095891

§ 371 Date: Mar. 1, 2018

(30) Foreign Application Priority Data
Sep. 18, 2015 (CN) 201510601330.0

(51) Int. Cl. G06F 21/31; G06F 9/54; G06F 21/54

(52) U.S. Cl. CPC G06F 21/31; G06F 9/542; G06F 2221/033; G06F 21/54; G06F 9/543

(57) ABSTRACT

Disclosed are a method and a device for controlling a top floating window and a mobile terminal. The method includes: acquiring an accessibility event in an operating system of a mobile terminal; judging whether the top floating window exists according to the accessibility event; and when the top floating window exists, receiving an instruction sent by a user for triggering the top floating window, and providing an identity verification interface according to the instruction.

### CROSS-REFERENCE TO RELATED APPLICATIONS

This application is a U.S. national phase application of International Application No. PCT/CN2016/095891, filed Aug. 18, 2018, which claims priority to and benefits of Chinese Patent Application Serial No. 201510601330.0, filed with the State Intellectual Property Office of P. R. China on Sep. 18, 2015, the entire content of which is incorporated herein by reference.

### TECHNICAL FIELD

The present disclosure relates to the field of mobile terminal technology, and more particularly, to a method and a device for controlling a top floating window and a mobile terminal.

### BACKGROUND

In daily life, a user may utilize a mobile terminal to realize various operations. For example, the user may chat with others, take photos and transmit documents through a communication application on a phone.

Some applications installed on the phone may employ floating window technology to force a bubble pop up on the phone in any case. For example, for a communication application FB (Facebook) Messenger, a chat window may pop up as long as a chat message is received. The bubbles may pop up for dozens to hundreds of times a day, which interfere the user. Even worse, the bubble cannot be prevented, such that a floating window in a form of pop-up bubble can be opened by anyone. Therefore, privacy of the user is easily revealed, thereby making security very poor.

### SUMMARY

Embodiments of the present disclosure provide a method for controlling a top floating window. The method includes: acquiring an accessibility event in an operating system of a mobile terminal; judging whether the top floating window exists according to the accessibility event; and when the top floating window exists, receiving an instruction sent by a user for triggering the top floating window, and providing an identity verification interface according to the instruction.

Embodiments of the present disclosure provide a terminal device. The terminal device includes a housing, a processor, a memory, a circuit board, and a power supply circuit. The circuit board is enclosed by the housing. The processor and the memory are positioned on the circuit board. The power supply circuit is configured to provide power for respective circuits or components of the terminal device. The memory is configured to store executable program codes. The processor is configured to run a program corresponding to the executable program codes by reading the executable program codes stored in the memory, to perform the above method for controlling a top floating window.

Embodiments of the present disclosure provide a method for identifying a top floating window. The method includes: acquiring an accessibility event in an operating system of a mobile terminal; judging whether the accessibility event includes an accessibility event of window state change and an accessibility event of window content change and whether an application package name corresponding to the accessibility event of window state change is same with that corresponding to the accessibility event of window content change; and when the accessibility event includes the accessibility event of window state change and the accessibility event of window content change and the application package name corresponding to the accessibility event of window state change is same with that corresponding to the accessibility event of window content change, judging that the window is the top floating window.

Embodiments of the present disclosure provide a mobile terminal. The mobile terminal includes a housing, a processor, a memory, a circuit board, and a power supply circuit. The circuit board is enclosed by the housing. The processor and the memory are positioned on the circuit board. The power supply circuit is configured to provide power for respective circuits or components of the terminal device. The memory is configured to store executable program codes. The processor is configured to run a program corresponding to the executable program codes by reading the executable program codes stored in the memory, to perform the above method for identifying a top floating window.

Embodiments of the present disclosure provide a storage medium with one or more modules stored. When the one or more modules are executed by an electronic device, the electronic device is configured to execute the above method for controlling a top floating window or the above method for identifying a top floating window.

Embodiments of the present disclosure provide an application program. When the application program is running, the above method for controlling a top floating window or the above method for identifying a top floating window are executed.

Additional aspects and advantages of embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart illustrating a method for controlling a top floating window according to an embodiment of the present disclosure;

FIG. 2 is a flow chart illustrating a method for controlling a top floating window according to another embodiment of the present disclosure;

FIG. 3 is a schematic diagram illustrating an act of setting a read permission of an accessibility event according to embodiments of the present disclosure;

FIG. 4 is a schematic diagram illustrating an act of setting a read permission of an accessibility event according to embodiments of the present disclosure;

FIG. 5 is a schematic diagram illustrating an act of setting a read permission of an accessibility event according to embodiments of the present disclosure;

FIG. 6 is a schematic diagram illustrating an act of setting a read permission of an accessibility event according to embodiments of the present disclosure;

FIG. 7 is a schematic diagram illustrating a top floating window of a mobile terminal according to embodiments of the present disclosure;

FIG. 8 is a flow chart illustrating a method for controlling a top floating window according to another embodiment of the present disclosure;

FIG. 9 is a schematic diagram illustrating a switching interface after a top floating window is triggered by a user in the related art;

FIG. 10 is a schematic diagram illustrating a switching interface after a top floating window is triggered by a user in embodiments of the present disclosure;

FIG. 11 is a flow chart illustrating a method for identifying a top floating window according to another embodiment of the present disclosure;

FIG. 12 is a flow chart illustrating a method for identifying a top floating window according to another embodiment of the present disclosure;

FIG. 13 is a block diagram illustrating a device for controlling a top floating window according to another embodiment of the present disclosure;

FIG. 14 is a block diagram illustrating a device for controlling a top floating window according to another embodiment of the present disclosure;

FIG. 15 is a block diagram illustrating a device for identifying a top floating window according to another embodiment of the present disclosure;

FIG. 16 is a block diagram illustrating a device for identifying a top floating window according to another embodiment of the present disclosure;

FIG. 17 is a block diagram illustrating a device for identifying a top floating window according to another embodiment of the present disclosure; and

FIG. 18 is a block diagram illustrating a mobile terminal according to an embodiment of the present disclosure.

### DETAILED DESCRIPTION

Reference will be made in detail to embodiments of the present disclosure. Examples of the embodiments are illustrated in the drawings. The same or similar elements and the elements having same or similar functions are denoted by like reference numerals throughout the descriptions. The embodiments described herein with reference to drawings are explanatory and illustrative, used to generally understand the present disclosure and are not construed to limit the present disclosure. Instead, embodiments of the present disclosure comprise all the variants, modifications and their equivalents within the spirit and scope of the present disclosure as defined by the claims.

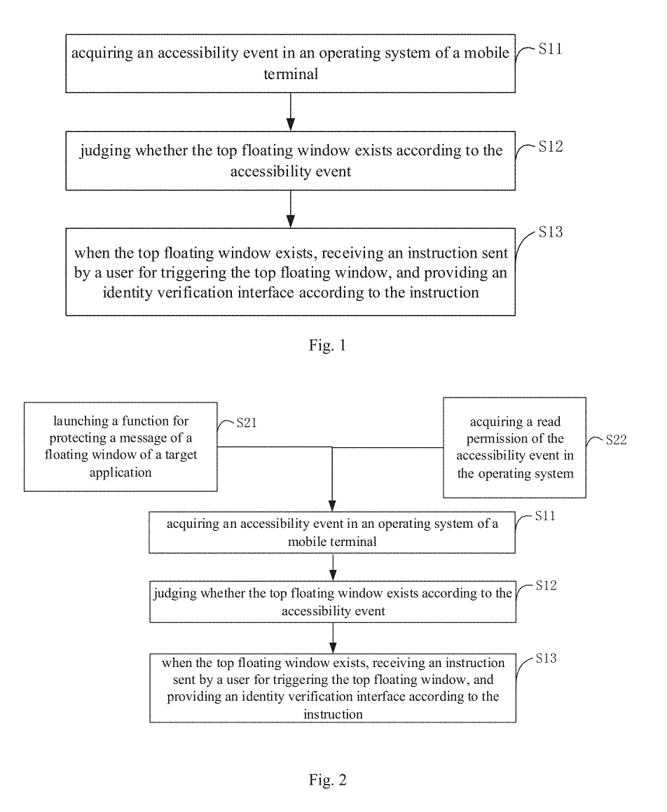

FIG. 1 is a flow chart illustrating a method for controlling a top floating window according to an embodiment of the present disclosure. The method may include the followings.

At act S11, an accessibility event in an operating system of a mobile terminal is acquired.

An executive body of embodiments of the present disclosure is an application of the mobile terminal.

The applications may refer to a software program running in an electronic device. The electronic device is for example a personal computer (PC), a cloud end device or a mobile terminal.

The mobile terminal is for example a smart phone, a tablet computer or the like.

An operating system (OS) is a computer program for managing and controlling computer hardware and software resources. The OS is basic system software running directly on a “bare computer”, and other software needs to be supported by the operating system to run. For example, the operation system is an Android operating system.

The accessibility event may be represented as a term of Accessibility event.

For example, an accessibility event that a top floating window of a new message of a communication application FB Messenger pops up in a phone is acquired by the application of the mobile terminal.

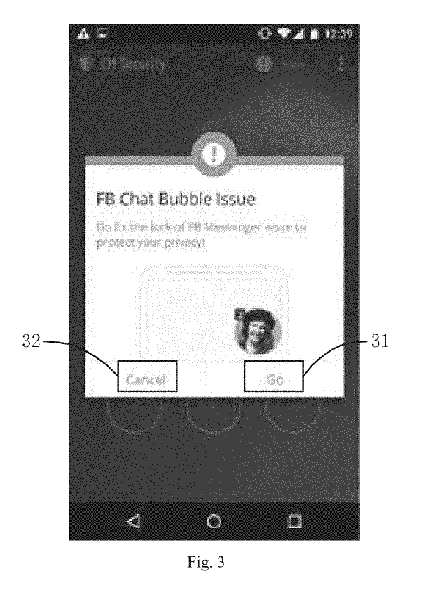

In an embodiment, as illustrated in FIG. 2, before the act S11, the method further includes the followings.

At act S21, a function for protecting a message of a floating window of a target application is launched.

The target application is for example an application of which privacy requires to be protected.

For example, the target application is the communication application FB Messenger.

In at least one embodiment of the present disclosure, launching the function for protecting the message of the floating window may be set by the user in advance.

In another embodiment, as illustrated in FIG. 2, before the act S11, the method further includes the followings.

At act S22, a read permission of the accessibility event in the operating system is acquired.

In at least one embodiment of the present disclosure, the read permission of the accessibility event may be set by the user in advance.

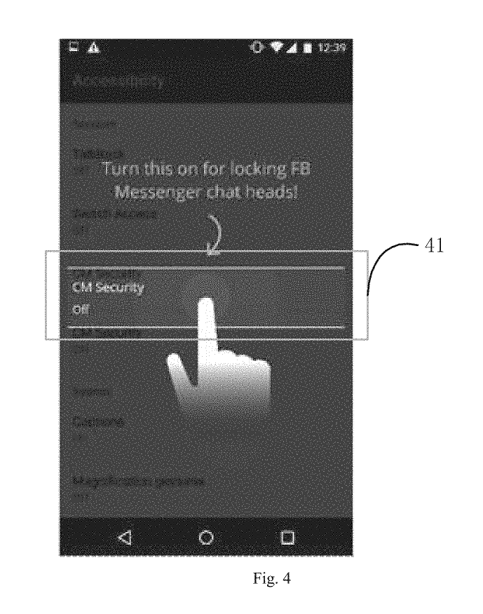

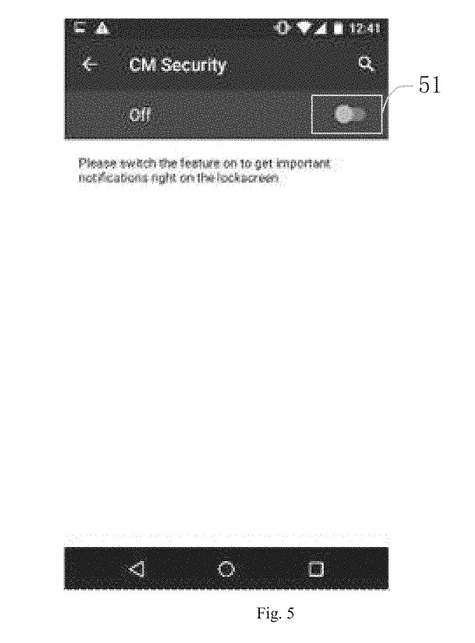

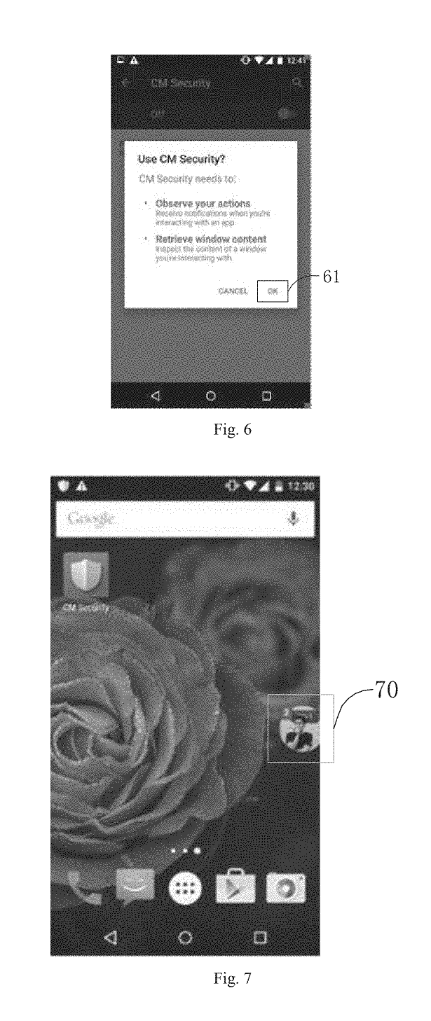

For example, as illustrated in FIG. 3, in embodiments of the present disclosure, the read permission of the accessibility event in the operating system may be set by using an application CM Security. In detail, a button 31 of “Go” illustrated in FIG. 3 may be touched such that the application CM Security is switched to an interface illustrated as FIG. 4. Alternatively, a button 32 of “Cancel” illustrated in FIG. 3 may be touched to quit an interface for setting the read permission of the accessibility event in the operating system. States of a label module 41 of the application CM Security illustrated in FIG. 4 includes “on” and “off”. When the state of the label module 41 of the application CM Security is set to be “off”, it indicates that no read permission is set to the accessibility event in the operating system. When the state of the label module 41 of the application CM Security is set to be “on”, it indicates that the read permission is set to the accessibility event in the operating system. As illustrated in FIG. 5, the user may slide a button 51 rightwards and an interface illustrated as FIG. 6 is switched to. A button 61 of “OK” illustrated in FIG. 6 may be touched by the user to set the read permission of the accessibility event in the operating system.

At act S12, it is judged whether the top floating window exists according to the accessibility event.

As illustrated in FIG. 7, FIG. 7 is a schematic diagram illustrating a top floating window in a mobile terminal. A module 70 illustrated in FIG. 7 is a top floating window that pops up after a new message is received by the communication application. The top floating window is configured to prompt the user that the new message is received, to remind the user to check.

In an embodiment of the present disclosure, judging whether the top floating window exists according to the accessibility event includes the followings. It is judged whether the accessibility event includes an accessibility event of window state change and an accessibility event of window content change and whether an application package name corresponding to the accessibility event of window state change is same with that corresponding to the accessibility event of window content change. When the accessibility event includes the accessibility event of window state change and the accessibility event of window content change, and the application package name corresponding to the accessibility event of window state change is same with that corresponding to the accessibility event of window content change, it is judged that the top floating window exists. An application corresponding to the top floating window is the application corresponding to the accessibility event of window state change and the accessibility event of window content change.

The changing of the window state may be represented by a term of Window state change, and the changing of the window content may be represented by a term of Window content change.

When the window of the mobile terminal is switched from foreground to background or from background to foreground, the accessibility event of Window state change may be triggered. When the content included in the window of the mobile terminal changes, the accessibility event of Window content change may be triggered.

For example, when the accessibility event A is acquired by an application, and when the accessibility event A includes the accessibility event of Window state change and the accessibility event of Window content change, and the application package names corresponding to the accessibility event of Window state change and the accessibility event of Window content change are same, it is determined that the top floating window exists.

At act S13, when the top floating window exists, an instruction sent by a user for triggering the top floating window is received, and an identity verification interface is provided according to the instruction.

The instruction for triggering the top floating window may be for example, via the user, a touch operation to the top floating window, a sliding operation to the top floating window and the like.

The identity verification interface is an unlocking interface.

The unlocking interface may be unlocked by a string, a fingerprint or a voiceprint.

In at least one embodiment of the present disclosure, when the top floating window exists and the instruction of the user for triggering the top floating window is received, providing the identity verification interface according to the instruction includes the followings. It is judged whether the application corresponding to the top floating window is the target application. When the application corresponding to the top floating window is the target application, the identity verification interface is provided according to the instruction. When the application corresponding to the top floating window is not the target application, an interface of the application corresponding to the top floating window is provided.

For example, after the instruction of the user for triggering the top floating window is received, and when the application corresponding to the top floating window is the communication application FB Messenger, and when the target application to which the function for protecting the message of the floating window is to be performed set by the user in advance is also the application FB Messenger, the identity verification interface for verifying the user identity is provided and verification information input by the user is received to verify the identity of the user.

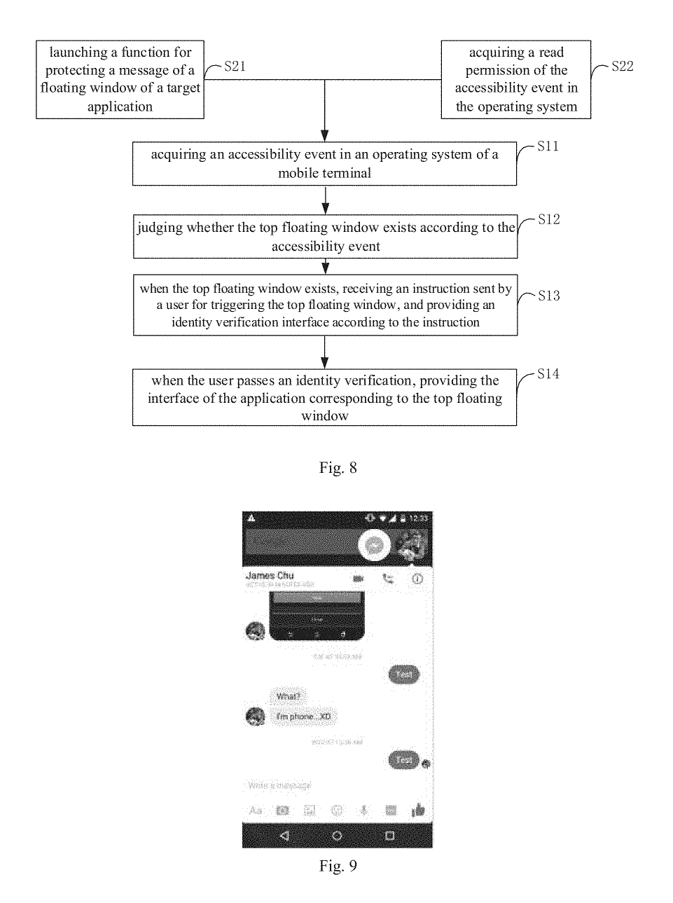

In another embodiment, as illustrated in FIG. 8, after the act S13, the method further includes the followings.

At act S14, when the user passes an identity verification, the interface of the application corresponding to the top floating window is provided.

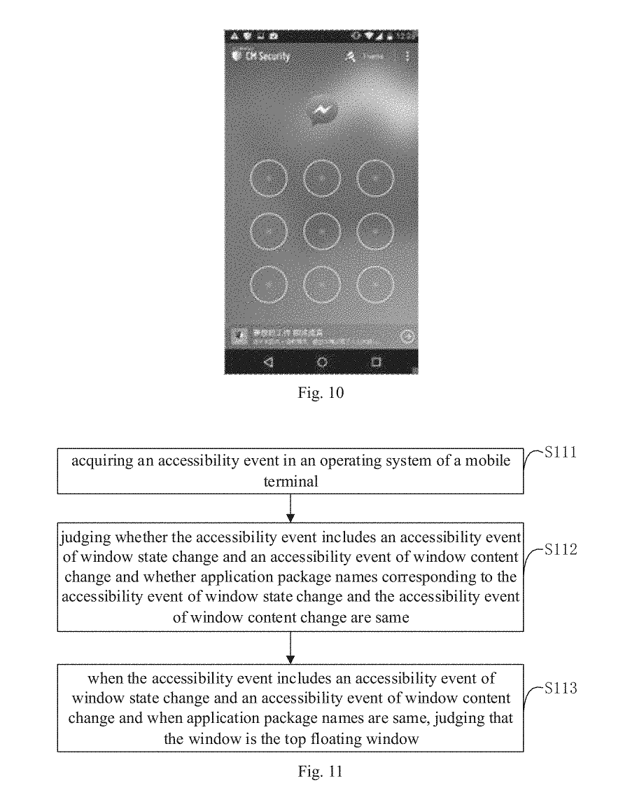

In the related art, when the user triggers the top floating window, the interface of the application corresponding to the top floating window is provided. For example, as illustrated in FIG. 9, when the user receives a prompt message for prompting a new message of the top floating window illustrated as FIG. 7 and touches the top floating window, a chat interface of the application corresponding to the top floating window is pushed in the mobile terminal. In embodiments of the present disclosure, with reference to FIG. 10, when the user triggers the top floating window, and the application corresponding to the top floating window is the target application, the identity verification interface is provided. After the user passes the identity verification, the interface of the application corresponding to the top floating window is provided.

In embodiments, after the top floating window of the mobile terminal is triggered, and the application corresponding to the top floating window is the target application, the identity verification interface is provided. Therefore, privacy of the user is protected, thereby improving security of user's data efficiently.

FIG. 11 is a flow chart illustrating a method for identifying a top floating window according to another embodiment of the present disclosure. The method includes the followings.

At act S111, an accessibility event in an operating system of a mobile terminal is acquired.

An executive body of the embodiment is an application of the mobile terminal.

The application may refer to a software program running in an electronic device. The electronic device is for example a personal computer (PC), a cloud end device or a mobile terminal.

The mobile terminal is for example a smart phone, a tablet computer or the like.

An operating system (OS) is a computer program for managing and controlling computer hardware and software resources. The OS is basic system software running directly on a “bare computer”, and other software needs to be supported by the operating system to run. For example, the operation system is an Android operating system.

The accessibility event may be represented as a term of Accessibility event.

For example, an accessibility event that a top floating window of a new message of a communication application FB Messenger pops up in a phone is acquired by the application of the mobile terminal.

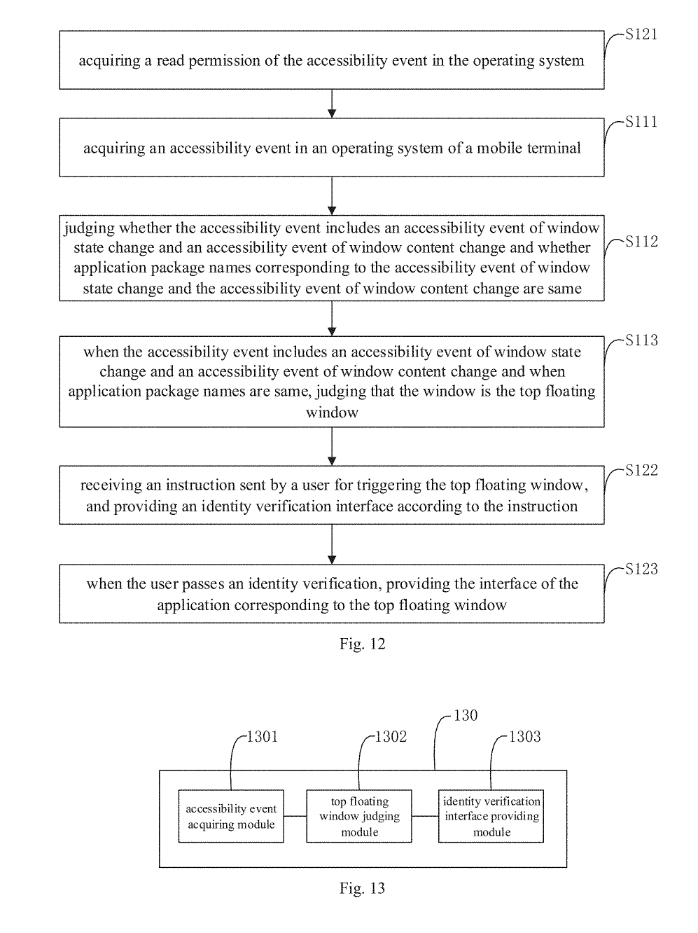

In another embodiment, as illustrated in FIG. 12, before acquiring the accessibility event in the operating system of the mobile terminal, the method further includes the followings.

At act S121, a read permission of the accessibility event in the operating system is acquired.

In at least one embodiment of the present disclosure, the read permission of the accessibility event may be set by the user in advance.

For example, as illustrated in FIG. 3, in embodiments of the present disclosure, the read permission of the accessibility event in the operating system may be set by using an application CM Security. In detail, a button 31 of “Go” illustrated in FIG. 3 may be touched such that the application CM Security is switched to an interface illustrated as FIG. 4. Alternatively, a button 32 of “Cancel” illustrated in FIG. 3 may be touched to quit an interface for setting the read permission of the accessibility event in the operating system. States of a label module 41 of the application CM Security illustrated in FIG. 4 includes “on” and “off”. When the state of the label module 41 of the application CM Security is set to be “off”, it indicates that no read permission is set to the accessibility event in the operating system. When the state of the label module 41 of the application CM Security is set to be “on”, it indicates that the read permission is set to the accessibility event in the operating system. As illustrated in FIG. 5, the user may slide a button 51 rightwards and an interface illustrated as FIG. 6 is switched to. The user may touch a button 61 of “OK” and the read permission of the accessibility event is set in the operating system.

At act S112, it is judged whether the accessibility event includes an accessibility event of window state change and an accessibility event of window content change, and whether an application package name corresponding to the accessibility event of window state change is same with that corresponding to the accessibility event of window content change.

The changing of the window state may be represented by a term of Window state change, and the changing of the window content may be represented by a term of Window content change.

When the window of the mobile terminal is switched from foreground to background or from background to foreground, the accessibility event of Window state change may be triggered. When the content included in the window of the mobile terminal changes, the accessibility event of Window content change may be triggered.

For example, when the accessibility event A is acquired by an application, it is judged whether the accessibility event A includes the accessibility event of Window state change and the accessibility event of Window content change, and whether the application package names corresponding to the accessibility event of Window state change and the accessibility event of Window content change are same.

At act S113, when the accessibility event includes the accessibility event of window state change and the accessibility event of window content change, and the application package name corresponding to the accessibility event of window state change is same with the application package name corresponding to the accessibility event of window content change, it is judged that the window is the top floating window.

For example, when the accessibility event A is acquired by the application, and when the accessibility event A includes the accessibility event of Window state change and the accessibility event of Window content change, and the application package names corresponding to the accessibility event of Window state change and the accessibility event of Window content change are same, it is determined that the top floating window exists.

In another embodiment, with reference to FIG. 12, the method further includes the followings.

At act S122, an instruction of the user for triggering the top floating window is received and an identity verification interface is provided according to the instruction.

The instruction for triggering the top floating window may be for example, via the user, a touch operation to the top floating window, a sliding operation to the top floating window and the like.

The identity verification interface is an unlocking interface.

The unlocking interface may be unlocked by a string, a fingerprint or a voiceprint.

At act S123, when the user passes an identity verification, the interface of the application corresponding to the top floating window is provided.

In the related art, when the user triggers the top floating window, the interface of the application corresponding to the top floating window is provided. For example, as illustrated in FIG. 9, when the user receives a prompt message for prompting a new message of the top floating window illustrated as FIG. 7 and touches the top floating window, a chat interface of the application corresponding to the top floating window is pushed in the mobile terminal. In embodiments of the present disclosure, with reference to FIG. 10, when the user triggers the top floating window, and the application corresponding to the top floating window is the target application, the identity verification interface is provided. After the user passes the identity verification, the interface of the application corresponding to the top floating window is provided.

In embodiments, when the accessibility event includes the accessibility event of window state change and the accessibility event of window content change and the application package name corresponding to the accessibility event of window state change is same with that corresponding to the accessibility event of window content change, it is judged that the window is the top floating window. Further, it may monitor that the top floating window may pop up in the mobile terminal in time, such that it may support to prevent the top floating window from popping up in the mobile terminal. Therefore, privacy of the user is protected, thereby improving security of user's data efficiently.

FIG. 13 is a block diagram illustrating a device for controlling a top floating window according to another embodiment of the present disclosure. The device 130 includes an accessibility event acquiring module 1301, a top floating window judging module 1302 and an identity verification interface providing module 1303.

The accessibility event acquiring module 1301 is configured to acquire an accessibility event in an operating system of a mobile terminal.

An executive body of the embodiment is an application of the mobile terminal.

The application may refer to a software program running in an electronic device. The electronic device is for example a personal computer (PC), a cloud end device or a mobile terminal.

The mobile terminal is for example a smart phone, a tablet computer or the like.

An operating system (OS) is a computer program for managing and controlling computer hardware and software resources. The OS is basic system software running directly on a “bare computer”, and other software needs to be supported by the operating system to run. For example, the operation system is an Android operating system.

The accessibility event may be represented as a term of Accessibility event.

For example, an accessibility event that a top floating window of a new message of a communication application FB Messenger pops up in a phone is acquired by the application of the mobile terminal.

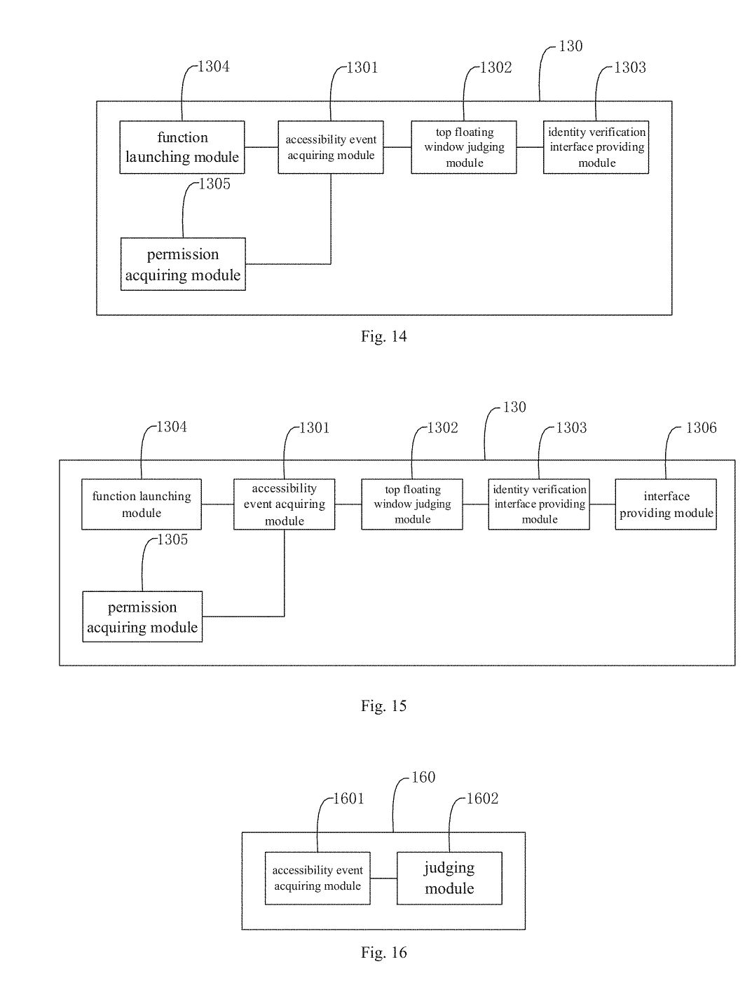

In an embodiment, as illustrated in FIG. 14, the device 130 further includes a function launching module 1304.

The function launching module 1304 is configured to launch a function for protecting a message of a floating window of a target application.

The target application is for example an application of which privacy requires to be protected.

For example, the target application is the communication application FB Messenger.

In at least one embodiment of the present disclosure, launching the function for protecting the message of a floating window may be set by the user in advance.

In another embodiment, as illustrated in FIG. 14, the device 130 further includes a permission acquiring module 1305.

The permission acquiring module 1305 is configured to acquire a read permission of the accessibility event in the operating system.

In at least one embodiment of the present disclosure, the read permission of the accessibility event may be set by the user in advance.

For example, as illustrated in FIG. 3, in embodiments of the present disclosure, the read permission of the accessibility event in the operating system may be set by using an application CM Security. In detail, a button 31 of “Go” illustrated in FIG. 3 may be touched such that the application CM Security is switched to an interface illustrated as FIG. 4. Alternatively, a button 32 of “Cancel” illustrated in FIG. 3 may be touched to quit an interface for setting the read permission of the accessibility event in the operating system. States of a label module 41 of the application CM Security illustrated in FIG. 4 includes “on” and “off”. When the state of the label module 41 of the application CM Security is set to be “off”, it indicates that no read permission is set to the accessibility event in the operating system. When the state of the label module 41 of the application CM Security is set to be “on”, it indicates that the read permission is set to the accessibility event in the operating system. As illustrated in FIG. 5, the user may slide a button 51 rightwards and an interface illustrated as FIG. 6 is switched to. A button 61 of “OK” illustrated in FIG. 6 may be touched by the user to set the read permission of the accessibility event in the operating system.

The top floating window judging module 1302 is configured to judge whether the top floating window exists according to the accessibility event.

As illustrated in FIG. 7, FIG. 7 is a schematic diagram illustrating a top floating window in a mobile terminal. A module 70 illustrated in FIG. 7 is a top floating window that pops up after a new message is received by the communication application. The top floating window is configured to prompt the user that the new message is received, to remind the user to check.

In another embodiment, the top layer floating judging module 1302 is configured to, when judging that the accessibility event includes an accessibility event of window state change and an accessibility event of window content change, and that an application package name corresponding to the accessibility event of window state change is same with that corresponding to the accessibility event of window content change, judge that the top floating window exists. The application corresponding to the top floating window is the application corresponding to the accessibility event of window state change and the accessibility event of window content change.

The changing of the window state may be represented by a term of Window state change, and the changing of the window content may be represented by a term of Window content change.

When the window of the mobile terminal is switched from foreground to background or from background to foreground, the accessibility event of Window state change may be triggered. When the content included in the window of the mobile terminal changes, the accessibility event of Window content change may be triggered.

For example, when the accessibility event A is acquired by an application, and when the accessibility event A includes the accessibility event of Window state change and the accessibility event of Window content change, and the application package names corresponding to the accessibility event of Window state change and the accessibility event of Window content change are same, it is determined that the top floating window exists.

The identity verification interface providing module 1303 is configured to, when the top floating window exists, receive an instruction sent by a user for triggering the top floating window, and to provide an identity verification interface according to the instruction.

The instruction for triggering the top floating window may be for example, via the user, a touch operation to the top floating window, a sliding operation to the top floating window and the like.

The identity verification interface is an unlocking interface.

The unlocking interface may be unlocked by a string, a fingerprint or a voiceprint.

In at least one embodiment of the present disclosure, the identity verification interface providing module 1303 is configured to judge whether the application corresponding to the top floating window is the target application. Further, the identity verification interface providing module 1303 is configured to, when the application corresponding to the top floating window is the target application, provide the identity verification interface according to the instruction. Moreover, the identity verification interface providing module 1303 is configured to, when the application corresponding to the top floating window is not the target application, provide an interface of the application corresponding to the top floating window.

For example, after the instruction of the user for triggering the top floating window is received, and when the application corresponding to the top floating window is the communication application FB Messenger, and when the target application to which the function for protecting the message of the floating window is to be performed set by the user in advance is also the application FB Messenger, the identity verification interface for verifying the user identity is provided and verification information input by the user is received to verify the identity of the user.

In another embodiment, as illustrated in FIG. 15, the device 130 further includes an interface providing module 1306.

The interface providing module 1306 is configured to, when the user passes an identity verification, provide the interface of the application corresponding to the top floating window.

In the related art, when the user triggers the top floating window, the interface of the application corresponding to the top floating window is provided. For example, as illustrated in FIG. 9, when the user receives a prompt message for prompting a new message of the top floating window illustrated as FIG. 7 and touches the top floating window, a chat interface of the application corresponding to the top floating window is pushed in the mobile terminal. In embodiments of the present disclosure, with reference to FIG. 10, when the user triggers the top floating window, and the application corresponding to the top floating window is the target application, the identity verification interface is provided. After the user passes the identity verification, the interface of the application corresponding to the top floating window is provided.

In embodiments, after the top floating window of the mobile terminal is triggered, and the application corresponding to the top floating window is the target application, the identity verification interface is provided. Therefore, privacy of the user is protected, thereby improving security of user's data efficiently.

FIG. 16 is a block diagram illustrating a device for identifying a top floating window according to another embodiment of the present disclosure. The device includes an accessibility event acquiring module 1601 and a judging module 1602.

The accessibility event acquiring module 1601 is configured to acquire an accessibility event in an operating system of a mobile terminal.

An executive body of the embodiment is an application of the mobile terminal.

The application may refer to a software program running in an electronic device. The electronic device is for example a personal computer (PC), a cloud end device or a mobile terminal.

The mobile terminal is for example a smart phone, a tablet computer or the like.

An operating system (OS) is a computer program for managing and controlling computer hardware and software resources. The OS is basic system software running directly on a “bare computer”, and other software needs to be supported by the operating system to run. For example, the operation system is an Android operating system.

The accessibility event may be represented as a term of Accessibility event.

For example, an accessibility event that a top floating window of a new message of a communication application FB Messenger is pushed in the phone is acquired by the application of the mobile terminal.

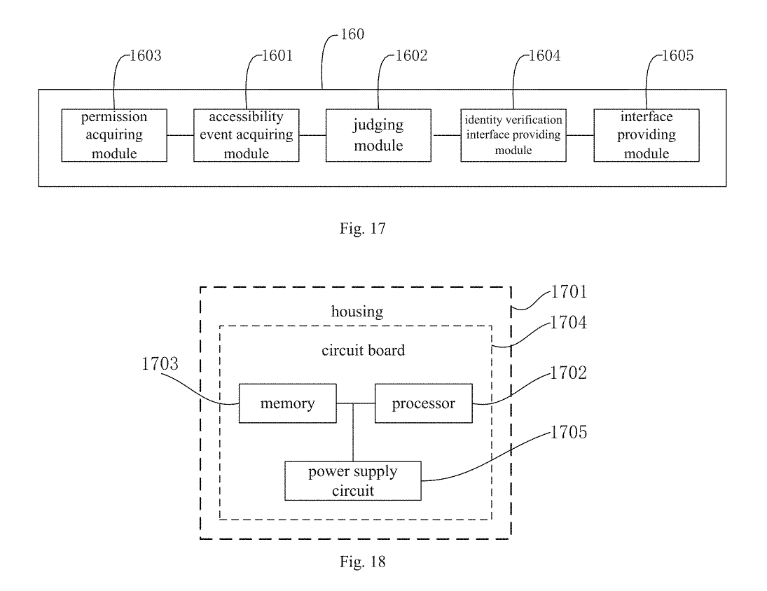

In another embodiment, as illustrated in FIG. 17, the device 160 further includes: a permission acquiring module 1603.

The permission acquiring module 1603 is configured to acquire a read permission of the accessibility event in the operating system.

In at least one embodiment of the present disclosure, the read permission of the accessibility event may be set by the user in advance.

For example, as illustrated in FIG. 3, in embodiments of the present disclosure, the read permission of the accessibility event in the operating system may be set by using an application CM Security. In detail, a button 31 of “Go” illustrated in FIG. 3 may be touched such that the application CM Security is switched to an interface illustrated as FIG. 4. Alternatively, a button 32 of “Cancel” illustrated in FIG. 3 may be touched to quit an interface for setting the read permission of the accessibility event in the operating system. States of a label module 41 of the application CM Security illustrated in FIG. 4 includes “on” and “off”. When the state of the label module 41 of the application CM Security is set to be “off”, it indicates that no read permission is set to the accessibility event in the operating system. When the state of the label module 41 of the application CM Security is set to be “on”, it indicates that the read permission is set to the accessibility event in the operating system. As illustrated in FIG. 5, the user may slide a button 51 rightwards and an interface illustrated as FIG. 6 is switched to. The user may touch a button 61 “OK” and the read permission of the accessibility event is set in the operating system.

The judging module 1602 is configured to judge whether the accessibility event includes an accessibility event of window state change and an accessibility event of window content change and whether an application package name corresponding to the accessibility event of window state change is same with that corresponding to the accessibility event of window content change; and judge that the window is the top floating window, when the accessibility event includes the accessibility event of window state change and the accessibility event of window content change and the application package name corresponding to the accessibility event of window state change is same with that corresponding to the accessibility event of window content change.

The changing of the window state may be represented by a term of Window state change, and the changing of the window content may be represented by a term of Window content change.

When the window of the mobile terminal is switched from foreground to background or from background to foreground, the accessibility event of Window state change may be triggered. When the content included in the window of the mobile terminal changes, the accessibility event of Window content change may be triggered.

For example, when the accessibility event A is acquired by an application, and when it is judged that the accessibility event A includes the accessibility event of Window state change and the accessibility event of Window content change, and that the application package names corresponding to the accessibility event of Window state change and the accessibility event of Window content change are same, it is determined that the top floating window exists.

In another embodiment, as illustrated in FIG. 17, the device 160 further includes an identity verification interface providing module 1604 and an interface providing module 1605.

The identity verification interface providing module 1604 is configured to receive an instruction of the user for triggering the top floating window and to provide an identity verification interface according to the instruction.

The instruction for triggering the top floating window may be for example, via the user, a touch operation to the top floating window, a sliding operation to the top floating window and the like.

The identity verification interface is an unlocking interface.

The unlocking interface may be unlocked by a string, a fingerprint or a voiceprint.

The interface providing module 1605 is configured to, when the user passes an identity verification, provide the interface of the application corresponding to the top floating window.

In the related art, when the user triggers the top floating window, the interface of the application corresponding to the top floating window is provided. For example, as illustrated in FIG. 9, when the user receives a prompt message for prompting a new message reminder of the top floating window illustrated as FIG. 7 and touches the top floating window, a chat interface of the application corresponding to the top floating window is pushed in the mobile terminal. In embodiments of the present disclosure, with reference to FIG. 10, when the user triggers the top floating window, and the application corresponding to the top floating window is the target application, the identity verification interface is provided. After the user passes the identity verification, the interface of the application corresponding to the top floating window is provided.

In embodiments, when the accessibility event includes the accessibility event of window state change and the accessibility event of window content change and the application package name corresponding to the accessibility event of window state change is same with the application package name corresponding to the accessibility event of window content change, it is judged that the window is the top floating window. Further, it may monitor that the top floating window may pop up in the mobile terminal in time, and it may support to prevent the top floating window from popping up in the mobile terminal. Therefore, privacy of the user is protected, thereby improving security of user's data efficiently.

Embodiments of the present disclosure further provide a mobile terminal. The mobile terminal includes a housing 1701, a processor 1702, a memory 1703, a circuit board 1704 and a power supply circuit 1705. The circuit board 1704 is enclosed by the housing 1701. The processor 1702 and the memory 1703 are positioned on the circuit board 1704. The power supply circuit 1705 is configured to provide power for respective circuits or components of the terminal device. The memory 1703 is configured to store executable program codes. The processor 1702 is configured to run a program corresponding to the executable program codes by reading the executable program codes stored in the memory 1703, to perform the followings.

At act S11′, an accessibility event in an operating system of a mobile terminal is acquired.

An executive body of embodiments of the present disclosure is an application of the mobile terminal.

The applications may refer to a software program running in an electronic device. The electronic device is for example a personal computer (PC), a cloud end device or a mobile terminal.

The mobile terminal is for example a smart phone, a tablet computer or the like.

An operating system (OS) is a computer program for managing and controlling computer hardware and software resources. The OS is basic system software running directly on a “bare computer”, and other software needs to be supported by the operating system to run. For example, the operation system is an Android operating system.

The accessibility event may be represented as a term of Accessibility event.

For example, an accessibility event that a top floating window of a new message of a communication application FB Messenger pops up in a phone is acquired by the application of the mobile terminal.

In an embodiment, the processor 1702 is configured to run a program corresponding to the executable program codes by reading the executable program codes stored in the memory 1703, to perform the followings.

At act S21′, a function for protecting a message of a floating window of a target application is launched.

The target application is for example an application of which privacy requires to be protected.

For example, the target application is the communication application FB Messenger.

In at least one embodiment of the present disclosure, launching the function for protecting the message of a floating window may be set by the user in advance.

In another embodiment, the processor 1702 is configured to run a program corresponding to the executable program codes by reading the executable program codes stored in the memory 1703, to perform the followings.

At act S22′, a read permission of the accessibility event in the operating system is acquired.

In at least one embodiment of the present disclosure, the read permission of the accessibility event may be set by the user in advance.

For example, as illustrated in FIG. 3, in embodiments of the present disclosure, the read permission of the accessibility event in the operating system may be set by using an application CM Security. In detail, a button 31 of “Go” illustrated in FIG. 3 may be touched such that the application CM Security is switched to an interface illustrated as FIG. 4. Alternatively, a button 32 of “Cancel” illustrated in FIG. 3 may be touched to quit an interface for setting the read permission of the accessibility event in the operating system. States of a label module 41 of the application CM Security illustrated in FIG. 4 includes “on” and “off”. When the state of the label module 41 of the application CM Security is set to be “off”, it indicates that no read permission is set to the accessibility event in the operating system. When the state of the label module 41 of the application CM Security is set to be “on”, it indicates that the read permission is set to the accessibility event in the operating system. As illustrated in FIG. 5, the user may slide a button 51 rightwards and an interface illustrated as FIG. 6 is switched to. A button 61 of “OK” illustrated in FIG. 6 may be touched by the user to set the read permission of the accessibility event in the operating system.

At act S12′, it is judged whether the top floating window exists according to the accessibility event.

As illustrated in FIG. 7, FIG. 7 is a schematic diagram illustrating a top floating window in a mobile terminal A module 70 illustrated in FIG. 7 is a top floating window pushed after a new message is received by the communication application. The top floating window is configured to prompt the user that the new message is received, to remind the user to check.

In an embodiment of the present disclosure, judging whether the top floating window exists according to the accessibility event includes the followings. It is judged whether the accessibility event includes an accessibility event of window state change and an accessibility event of window content change and whether an application package name corresponding to the accessibility event of window state change is same with that corresponding to the accessibility event of window content change. When the accessibility event includes the accessibility event of window state change and the accessibility event of window content change, and the application package names corresponding to the accessibility event of window state change is same with that corresponding to the accessibility event of window content change, it is judged that the top floating window exists. An application corresponding to the top floating window is the application corresponding to the accessibility event of window state change and the accessibility event of window content change.

The changing of the window state may be represented by a term of Window state change, and the changing of the window content may be represented by a term of Window content change.

When the window of the mobile terminal is switched from foreground to background or from background to foreground, the accessibility event of Window state change may be triggered. When the content included in the window of the mobile terminal changes, the accessibility event of Window content change may be triggered.

For example, when the accessibility event A is acquired by an application, and when the accessibility event A includes the accessibility event of Window state change and the accessibility event of Window content change, and the application package names corresponding to the accessibility event of Window state change and the accessibility event of Window content change are same, it is determined that the top floating window exists.

At act S13′, when the top floating window exists, an instruction sent by a user for triggering the top floating window is received, and an identity verification interface is provided according to the instruction.

The instruction for triggering the top floating window may be for example, via the user, a touch operation to the top floating window, a sliding operation to the top floating window and the like.

The identity verification interface is an unlocking interface.

The unlocking interface may be unlocked by a string, a fingerprint or a voiceprint.

In at least one embodiment of the present disclosure, when the top floating window exists and the instruction of the user for triggering the top floating window is received, providing the identity verification interface according to the instruction includes the followings. It is judged whether the application corresponding to the top floating window is the target application. When the application corresponding to the top floating window is the target application, the identity verification interface is provided according to the instruction. When the application corresponding to the top floating window is not the target application, an interface of the application corresponding to the top floating window is provided.

For example, after the instruction of the user for triggering the top floating window is received, and when the application corresponding to the top floating window is the communication application FB Messenger, and when the target application to which the function for protecting the message of a floating window is to be performed set by the user in advance is also the application FB Messenger, the identity verification interface for verifying the user identity is provided and verification information input by the user is received to verify the identity of the user.

In another embodiment, the processor 1702 is configured to run a program corresponding to the executable program codes by reading the executable program codes stored in the memory 1703, to perform the followings.

At act S14′, when the user passes an identity verification, the interface of the application corresponding to the top floating window is provided.

In the related art, when the user triggers the top floating window, the interface of the application corresponding to the top floating window is provided. For example, as illustrated in FIG. 9, when the user receives a prompt message for prompting a new message of the top floating window illustrated as FIG. 7 and touches the top floating window, a chat interface of the application corresponding to the top floating window is pushed in the mobile terminal. In embodiments of the present disclosure, with reference to FIG. 10, when the user triggers the top floating window, and the application corresponding to the top floating window is the target application, the identity verification interface is provided. After the user passes the identity verification, the interface of the application corresponding to the top floating window is provided.

In embodiments, after the top floating window of the mobile terminal is triggered, and the application corresponding to the top floating window is the target application, the identity verification interface is provided. Therefore, privacy of the user is protected, thereby improving security of user's data efficiently.

In another embodiment, the processor 1702 is configured to run a program corresponding to the executable program codes by reading the executable program codes stored in the memory 1703, to perform the followings.

At act S111′, an accessibility event in an operating system of a mobile terminal is acquired.

An executive body of the embodiment is an application of the mobile terminal.

The application may refer to a software program running in an electronic device. The electronic device is for example a personal computer (PC), a cloud end device or a mobile terminal.

The mobile terminal is for example a smart phone, a tablet computer or the like.

An operating system (OS) is a computer program for managing and controlling computer hardware and software resources. The OS is basic system software running directly on a “bare computer”, and other software needs to be supported by the operating system to run. For example, the operation system is an Android operating system.

The accessibility event may be represented as a term of Accessibility event.

For example, an accessibility event that a top floating window of a new message of a communication application FB Messenger pops up in a phone is acquired by the application of the mobile terminal.

In another embodiment, the processor 1702 is configured to run a program corresponding to the executable program codes by reading the executable program codes stored in the memory 1703, to perform the followings.

At act S121′, a read permission of the accessibility event in the operating system is acquired.

In at least one embodiment of the present disclosure, the read permission of the accessibility event may be set by the user in advance.

For example, as illustrated in FIG. 3, in embodiments of the present disclosure, the read permission of the accessibility event in the operating system may be set by using an application CM Security. In detail, a button 31 of “Go” illustrated in FIG. 3 may be touched such that the application CM Security is switched to an interface illustrated as FIG. 4. Alternatively, a button 32 of “Cancel” illustrated in FIG. 3 may be touched to quit an interface for setting the read permission of the accessibility event in the operating system. States of a label module 41 of the application CM Security illustrated in FIG. 4 includes “on” and “off”. When the state of the label module 41 of the application CM Security is set to be “off”, it indicates that no read permission is set to the accessibility event in the operating system. When the state of the label module 41 of the application CM Security is set to be “on”, it indicates that the read permission is set to the accessibility event in the operating system. As illustrated in FIG. 5, the user may slide a button 51 rightwards and an interface illustrated as FIG. 6 is switched to. The user may touch a button 61 of “OK” and the read permission of the accessibility event is set in the operating system.

At act S112′, it is judged whether the accessibility event includes an accessibility event of window state change and an accessibility event of window content change, and whether an application package name corresponding to the accessibility event of window state change is same with that corresponding to the accessibility event of window content change.

The changing of the window state may be represented by a term of Window state change, and the changing of the window content may be represented by a term of Window content change.

When the window of the mobile terminal is switched from foreground to background or from background to foreground, the accessibility event of Window state change may be triggered. When the content included in the window of the mobile terminal changes, the accessibility event of Window content change may be triggered.

For example, when the accessibility event A is acquired by an application, it is judged whether the accessibility event A includes the accessibility event of Window state change and the accessibility event of Window content change, and whether the application package names corresponding to the accessibility event of Window state change and the accessibility event of Window content change are same.

At act S113′, when the accessibility event includes the accessibility event of window state change and the accessibility event of window content change, and the application package name corresponding to the accessibility event of window state change is same with the application package name corresponding to the accessibility event of window content change, it is judged that the window is the top floating window.

For example, when the accessibility event A is acquired by an application, and when the accessibility event A includes the accessibility event of Window state change and the accessibility event of Window content change, and the application package names corresponding to the accessibility event of Window state change and the accessibility event of Window content change are same, it is determined that the top floating window exists.

In another embodiment, the processor 1702 is configured to run a program corresponding to the executable program codes by reading the executable program codes stored in the memory 1703, to perform the followings.

At act S122′, an instruction of the user for triggering the top floating window is received and an identity verification interface is provided according to the instruction.

The instruction for triggering the top floating window may be for example, via the user, a touch operation to the top floating window, a sliding operation to the top floating window and the like.

The identity verification interface is an unlocking interface.

The unlocking interface may be unlocked by a string, a fingerprint or a voiceprint.

At act S123′, when the user passes an identity verification, the interface of the application corresponding to the top floating window is provided.

In the related art, when the user triggers the top floating window, the interface of the application corresponding to the top floating window is provided. For example, as illustrated in FIG. 9, when the user receives a prompt message for prompting a new message of the top floating window illustrated as FIG. 7 and touches the top floating window, a chat interface of the application corresponding to the top floating window is pushed in the mobile terminal. In embodiments of the present disclosure, with reference to FIG. 10, when the user triggers the top floating window, and the application corresponding to the top floating window is the target application, the identity verification interface is provided. After the user passes the identity verification, the interface of the application corresponding to the top floating window is provided.

In embodiments, when the accessibility event includes the accessibility event of window state change and the accessibility event of window content change and the application package name corresponding to the accessibility event of window state change is same with that corresponding to the accessibility event of window content change, it is judged that the window is the top floating window. Further, it may monitor that the top floating window may pop up in the mobile terminal in time, such that it may support to prevent the top floating window from popping up in the mobile terminal. Therefore, privacy of the user is protected, thereby improving security of user's data efficiently.

The electronic device may have various forms, including but not limited to:

(1) A mobile communication device: this typed device has a capacity of mobile communicating, and has a main function of providing voice, data communication. This typed device includes a smart phone (such as an iPhone), a multi-media phone, a functional phone and a low-level phone.

(2) A super-mobile personal computer device: this typed device pertains to a personal computer having a capacity of computing and processing and generally having a capacity of accessing mobile Internet. This typed device includes: PDA (Personal Digital Assistant), MID (Mobile Internet Device) and UMPC devices (Ultra-mobile Personal Computer), such as an iPad.

(3) Portable entertainment equipment: this typed device may display or play multi-medium content. This typed device includes: an audio, video player (such as iPod), a handheld game player, an E-book, intelligent playthings, and portable vehicle navigation equipment.

(4) Other electronic device having a capacity of data interaction.

Embodiments of the present disclosure provide a storage medium with one or more modules stored. When the one or more modules are executed by an electronic device, the electronic device is configured to execute the method for controlling a top floating window provided in any one of above embodiments of the present disclosure.

Embodiments of the present disclosure provide a storage medium with one or more modules stored. When the one or more modules are executed by an electronic device, the electronic device is configured to execute the method for identifying a top floating window provided in any one of above embodiments of the present disclosure.

Embodiments of the present disclosure provide an application program. When the application program is running, the method for controlling a top floating window provided in any one of above embodiments of the present disclosure is executed.

Embodiments of the present disclosure provide an application program. When the application program is running, the method for identifying a top floating window provided in any one of above embodiments of the present disclosure is executed.

It is to be illustrated that, in description of the specification, terms such as “first” and “second” are configured herein for purposes of description and are not intended to indicate or imply relative importance or significance. Furthermore, in the description of the present disclosure, “a plurality of” refers to two or more than two, unless otherwise specified.

Any process or method described in a flow chart or described herein in other ways may be understood to include one or more modules, segments or portions of codes of executable instructions for achieving specific logical functions or acts in the process, and the scope of a preferred embodiment of the present disclosure includes other implementations, in which the functions may be executed in other orders instead of the order illustrated or discussed, including in a basically simultaneous manner or in a reverse order, which should be understood by those skilled in the art.

It should be understood that each part of the present disclosure may be realized by the hardware, software, firmware or their combination. In the above embodiments, a plurality of acts or methods may be realized by the software or firmware stored in the memory and executed by the appropriate instruction execution system. For example, when it is realized by the hardware, likewise in another embodiment, the acts or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the acts in the above exemplifying method of the present disclosure may be achieved by commanding the related hardware with programs. The programs may be stored in a computer readable storage medium, and the programs include one or a combination of the acts in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

In the description of the specification, terms such as “an embodiment,” “some embodiments,” “one embodiment”, “another example,” “an example,” “a specific example,” or “some examples,” means that a particular feature or characteristic described in connection with the embodiment or example is included in at least one embodiment or example of the present disclosure. In the specification, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

1. A method for controlling a top floating window, comprising:
acquiring an accessibility event in an operating system of a mobile terminal;
judging whether the top floating window exists according to the accessibility event; and
when the top floating window exists, receiving an instruction sent by a user for triggering the top floating window, and providing an identity verification interface according to the instruction.

2. The method according to claim 1, wherein judging whether the top floating window exists according to the accessibility event comprises:
judging whether the accessibility event comprises an accessibility event of window state change and an accessibility event of window content change and whether an application package name corresponding to the accessibility event of window state change is same with that corresponding to the accessibility event of window content change; and
when the accessibility event comprises the accessibility event of window state change and the accessibility event of window content change, and the application package name corresponding to the accessibility event of window state change is same with that corresponding to the accessibility event of window content change, judging that the top floating window exists, wherein an application corresponding to the top floating window is the application.

3. The method according to claim 1, wherein, before acquiring the accessibility event in the operating system of the mobile terminal, the method further comprises:
launching a function for protecting a message of a floating window of a target application.

4. The method according to claim 1, wherein, before acquiring the accessibility event in the operating system of the mobile terminal, the method further comprises:
acquiring a read permission of the accessibility event in the operating system.

5. The method according to claim 3, wherein providing an identity verification interface according to the instruction comprises:
judging whether the application corresponding to the top floating window is the target application;
when the application corresponding to the top floating window is the target application, providing the identity verification interface according to the instruction; and
when the application corresponding to the top floating window is not the target application, providing an interface of the application corresponding to the top floating window.

6. The method according to claim 1, further comprising:
when the user passes an identity verification, providing the interface of the application corresponding to the top floating window.

7-12. (canceled)

13. A mobile terminal, comprising:
a housing;
a processor;
a memory;
a circuit board and a power supply circuit;
wherein the circuit board is enclosed by the housing; the processor and the memory are positioned on the circuit board; the power supply circuit is configured to provide power for respective circuits or components of the mobile terminal;
wherein the memory is configured to store executable program codes; and
wherein the processor is configured to run a program corresponding to the executable program codes by reading the executable program codes stored in the memory, to perform a method for controlling a top floating window, the method comprising:
acquiring an accessibility event in an operating system of a mobile terminal;
judging whether the top floating window exists according to the accessibility event; and
when the top floating window exists, receiving an instruction sent by a user for triggering the top floating window, and providing an identity verification interface according to the instruction.

14-22. (canceled)

23. A non-transitory computer-readable storage medium, having one or more modules stored, wherein when the one or more modules are executed by an electronic device, the electronic device is configured to execute a method for controlling a top floating window, the method comprising:
acquiring an accessibility event in an operating system of a mobile terminal;
judging whether the top floating window exists according to the accessibility event; and
when the top floating window exists, receiving an instruction sent by a user for triggering the top floating window, and providing an identity verification interface according to the instruction.

24. (canceled)

25. The mobile terminal according to claim 13, wherein the processor is configured to judge whether the top floating window exists according to the accessibility event by acts of:
judging whether the accessibility event comprises an accessibility event of window state change and an accessibility event of window content change and whether an application package name corresponding to the accessibility event of window state change is same with that corresponding to the accessibility event of window content change; and
when the accessibility event comprises the accessibility event of window state change and the accessibility event of window content change, and the application package name corresponding to the accessibility event of window state change is same with that corresponding to the accessibility event of window content change, judging that the top floating window exists, wherein an application corresponding to the top floating window is the application.

26. The mobile terminal according to claim 13, wherein the processor is further configured to:
launch a function for protecting a message of a floating window of a target application before acquiring the accessibility event in the operating system of the mobile terminal.

27. The mobile terminal according to claim 13, wherein the processor is further configured to:
acquire a read permission of the accessibility event in the operating system before acquiring the accessibility event in the operating system of the mobile terminal.

28. The mobile terminal according to claim 26, wherein the processor is configured to provide an identity verification interface according to the instruction by acts of:
judging whether the application corresponding to the top floating window is the target application;
when the application corresponding to the top floating window is the target application, providing the identity verification interface according to the instruction; and
when the application corresponding to the top floating window is not the target application, providing an interface of the application corresponding to the top floating window.

29. The mobile terminal according to claim 13, wherein the processor is further configured to:
when the user passes an identity verification, provide the interface of the application corresponding to the top floating window.

30. The non-transitory computer-readable storage medium according to claim 23, wherein judging whether the top floating window exists according to the accessibility event comprises:
judging whether the accessibility event comprises an accessibility event of window state change and an accessibility event of window content change and whether an application package name corresponding to the accessibility event of window state change is same with that corresponding to the accessibility event of window content change; and
when the accessibility event comprises the accessibility event of window state change and the accessibility event of window content change, and the application package name corresponding to the accessibility event of window state change is same with that corresponding to the accessibility event of window content change, judging that the top floating window exists, wherein an application corresponding to the top floating window is the application.

31. The non-transitory computer-readable storage medium according to claim 23, wherein, before acquiring the accessibility event in the operating system of the mobile terminal, the method further comprises:
launching a function for protecting a message of a floating window of a target application.

32. The non-transitory computer-readable storage medium according to claim 23, wherein, before acquiring the accessibility event in the operating system of the mobile terminal, the method further comprises:
acquiring a read permission of the accessibility event in the operating system.

33. The non-transitory computer-readable storage medium according to claim 31, wherein providing an identity verification interface according to the instruction comprises:
judging whether the application corresponding to the top floating window is the target application;
when the application corresponding to the top floating window is the target application, providing the identity verification interface according to the instruction; and
when the application corresponding to the top floating window is not the target application, providing an interface of the application corresponding to the top floating window.

34. The non-transitory computer-readable storage medium according to claim 23, wherein the method further comprises:
when the user passes an identity verification, providing the interface of the application corresponding to the top floating window.
